(19) United States
(12) Patent Application Publication
(10) Pub. No.: US 2023/0186371 A1
(43) Pub. Date: Jun. 15, 2023

(54) COMPUTER ANALYSIS OF ELECTRONIC ORDER MANAGEMENT FOR PRODUCT FULFILLMENT

(71) Applicant: International Business Machines Corporation, Armonk, NY (US)

(72) Inventors: Kedar Kulkarni, Bangalore (IN); Reginald Eugene Bryant, Nairobi (KE); Isaac Waweru Wambugu, Nairobi (KE); Pavithra Harsha, Pleasantville, NY (US); Brian Leo Quanz, Yorktown Heights, NY (US); Chandrasekhar Narayanaswami, Wilton, CT (US)

(21) Appl. No.: 17/644,247

(22) Filed: Dec. 14, 2021

(51) Int. Cl. G06Q 30/06; G06Q 30/00

(52) U.S. Cl. CPC G06Q 30/0635; G06Q 30/018

(57) ABSTRACT

In an approach to improve order management by performing sustainable order fulfillment optimization through computer analysis, embodiments receive an order from a user through the order management system for performing sustainable order fulfillment. Further, embodiments estimate carbon emissions and economic costs of fulfilling the order from a plurality of nodes, and output an optimal sustainable order fulfillment. Additionally, responsive to receiving confirmation to implement the output optimal sustainable order fulfillment, embodiments place the optimal sustainable order fulfillment for the received order.

### BACKGROUND OF THE INVENTION

The present invention relates generally to the field of order management systems, and more particularly to sustainable fulfillment optimization in an order management system (OMS).

Order fulfillment is in the complete process from point of sales inquiry to delivery of a product to the customer. Sometimes order fulfillment is used to describe the narrower act of distribution or the logistics function, however, in the broader sense it refers to the way firms respond to customer orders. An order management system (OMS) is the single source of truth for all orders across channels. It makes it possible for retail brands to view product availability across enterprise-wide locations, including stores, warehouses, distribution centers (DC) and/or third-party logistics (3PLs). Modem order management systems built for omnichannel environments enable retailers to connect the dots between orders, customers, and inventory -getting product to shoppers quickly and more efficiently. One of the core motivations of retailers today is to reduce click to door time (e.g., shipping/delivery time from online purchase to a user’s door). With an omnichannel OMS as the backbone, reducing click to door time can be achieved through smart order routing with modern fulfillment methods to reduce the carbon footprint associated with delivery/shipping services. Sustainable fulfillment may be optimized in two ways. First is through smart order routing, which aligns supply and demand to use fewer resources and cut waste. The second is the store network, which can be leveraged as a fulfillment channel to reduce the carbon footprint associated with delivery/shipping services. In combination, these two practices can help achieve the end result of sustainability.

### SUMMARY

Embodiments of the present invention disclose a computer-implemented method, a computer program product, and a system for improving order management by performing sustainable order fulfillment optimization through computer analysis, the computer-implemented method comprising: receiving an order from a user through the order management system for performing sustainable order fulfillment; estimating carbon emissions and economic costs of fulfilling the order from a plurality of nodes; outputting an optimal sustainable order fulfillment, wherein the optimal sustainable order fulfillment comprises an optimal: node, carrier, transport mode, and vehicle to fulfill the order based on consumer’s preference; and responsive to receiving confirmation to implement the output optimal sustainable order fulfillment, placing the optimal sustainable order fulfillment for the received order.

### BRIEF DESCRIPTION OF THE DRAWINGS

FIG. 1A is a functional block diagram illustrating a distributed data processing environment, in accordance with an embodiment of the present invention;

FIG. 1B is a functional block diagram illustrating an exemplary scenario, in accordance with an embodiment of the present invention;

FIG. 1C is a functional block diagram illustrating an exemplary scenario, in accordance with an embodiment of the present invention;

FIGS. 2A - 2B are a functional block diagram illustrating a distributed data processing environment of a sustainable order fulfillment optimization component, in accordance with an embodiment of the present invention;

FIGS. 3A - 3B illustrate operational steps of the sustainable order fulfillment optimization component, on a server computer within the distributed data processing environment of FIG. 1A, for sustainable order fulfillment optimization on an order management system, in accordance with an embodiment of the present invention;

FIG. 4 illustrates operational steps of the sustainable order fulfillment optimization component, on a server computer within the distributed data processing environment of FIG. 1A, for sustainable order fulfillment optimization on an order management system, in accordance with an embodiment of the present invention; and

FIG. 5 depicts a block diagram of components of the server computer executing the sustainable order fulfillment optimization component within the distributed data processing environment of FIG. 1A, in accordance with an embodiment of the present invention.

### DETAILED DESCRIPTION

Embodiments of the present invention recognize that order fulfillment is the last-mile delivery of finished goods to consumers and that the main objective of order fulfillment is to fulfill orders from different destinations with requested goods / items from different fulfillment nodes in a company’s network (e.g., distribution centers (DC’s), and/or stores). Further, embodiments of the present invention recognize that order fulfillment optimization typically minimizes a company’s cost-to-serve by including the following components: shipping costs, load balancing between different nodes in the network, future markdown costs, and lost sales cost.

Additionally, embodiments of the present invention recognize that in the recent times, companies have started measuring and reducing the carbon footprint of different operations in a company’s supply chains. Embodiments of the present invention recognize that numerous companies submit annual climate change reports to the CDP (Carbon Disclosure Project), that include a company’s direct and indirect (supply chain) emissions, due to upstream and downstream supply chain partners. Further, embodiments of the present invention recognize that companies also publish annual carbon emission reduction goals. Thus, the pressure on said companies to reduce and subscribe to greenhouse gas (GHG) emission reduction goals is increasing. Embodiments of the present invention recognize that one of the main problems in the art is: how effective sustainable order fulfillment in line with the company’s requirement of reducing both i) costs-to-serve and ii) GHG emissions can be enabled. Embodiments of the present invention recognize that, during the As-Is process, order fulfillment is optimized based chiefly on economic considerations (e.g., shipping and item costs), and that order fulfillment does not explicitly account for GHG emissions generated due to freight-transport of ordered goods. Additionally, embodiments of the present invention recognize that, during the To-be process, order fulfillments comprise the following features: (i) estimated order distance depending on (estimated) transport mode, freight delivery-mode: Less-Than-Truckload (LTL) versus Full-Truck-Load (FTL), (ii) estimated emissions as function of order distance, transport mode, vehicle characteristics / loading factors / idling time / empty miles / pickup and delivery times (in LTL), time spent by package at transit node during transport mode-switch, (iii) estimated dollar costs of emissions, (iv) and explicitly a) minimized emission costs along with other economic criteria, or b) minimized economic costs while constraining carbon emission costs.

Embodiments of the present invention improve the art and solve the problems by stated above by performing sustainable order fulfillment optimization in line with company’s requirement of reducing costs of serving and carbon emissions. Embodiments of the present invention execute a computer analysis of electronic order management for product fulfillment and output optimized fulfillment parameters based on the analysis, wherein the optimized fulfillment parameters comprise sustainable order fulfillment parameters. In various embodiments, fulfillment parameters and sustainable order fulfillment parameters are predetermined. Further, embodiments of the present invention improve the art and solve the problems by stated above by receiving new order from a consumer through order management system (OMS) for performing sustainable order fulfillment, estimating carbon emissions and economic costs of fulfilling the order from different (several thousand) nodes, and outputting optimal node, carrier, transport mode and vehicle to fulfill the order depending on consumer’s preference.

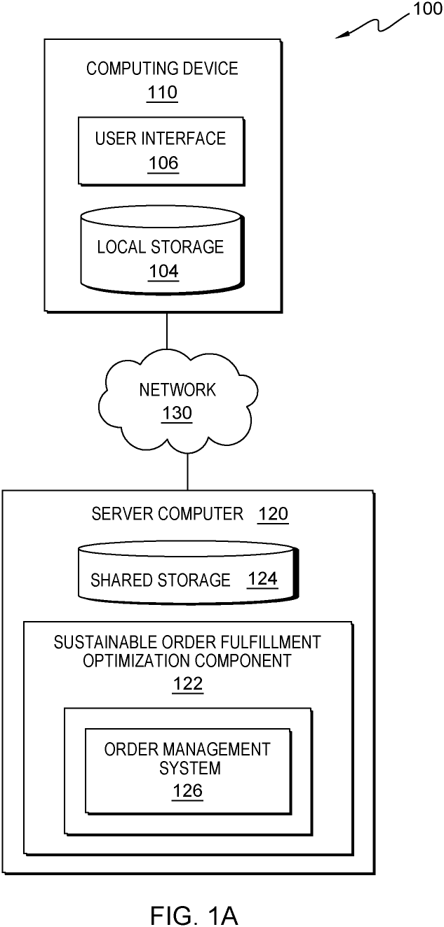

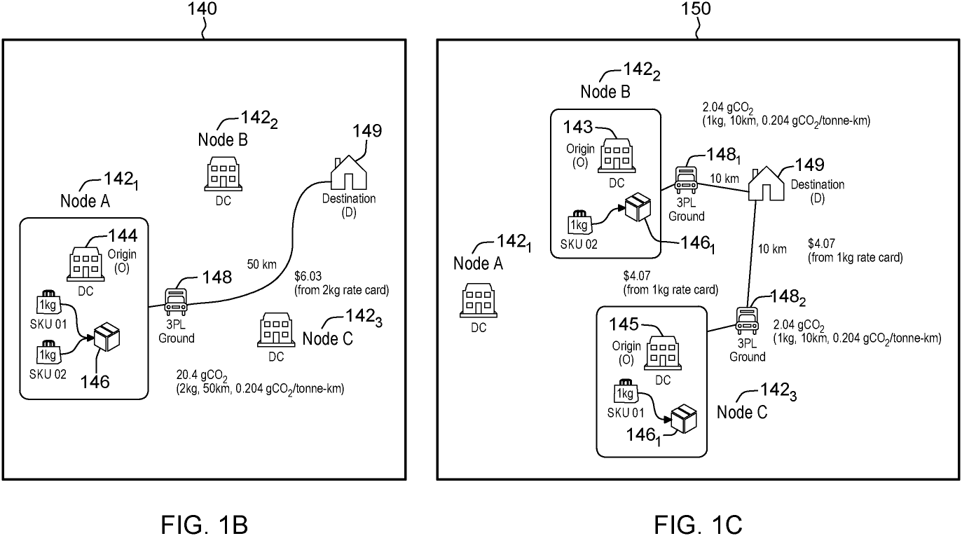

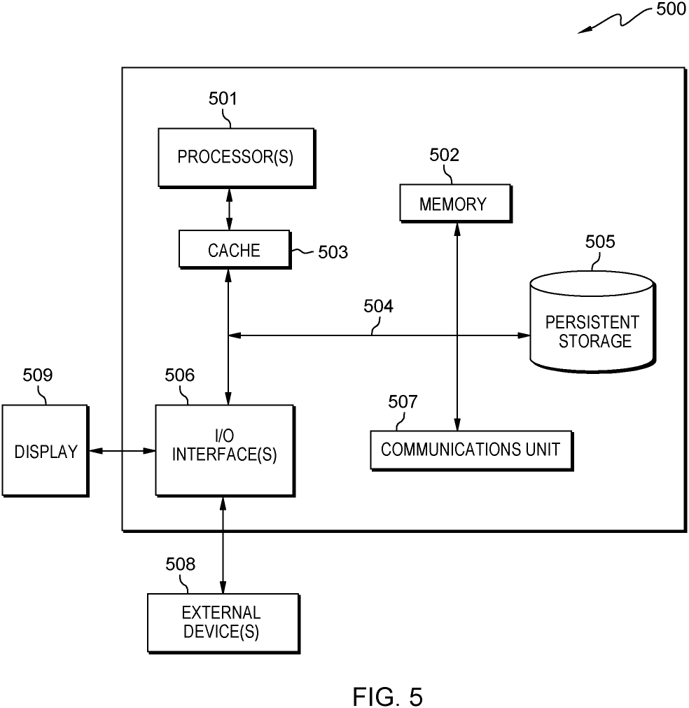

Implementation of embodiments of the invention may take a variety of forms, and exemplary implementation details are discussed subsequently with reference to the Figures (i.e., FIG. 1A - FIG. 5).

FIG. 1A is a functional block diagram illustrating a distributed data processing environment, generally designated 100, in accordance with one embodiment of the present invention. The term “distributed” as used in this specification describes a computer system that includes multiple, physically distinct devices that operate together as a single computer system. FIG. 1A provides only an illustration of one implementation and does not imply any limitations with regard to the environments in which different embodiments may be implemented. Many modifications to the depicted environment may be made by those skilled in the art without departing from the scope of the invention as recited by the claims. Distributed data processing environment 100 includes computing device 110 and server computer 120 interconnected over network 130.

Network 130 may be, for example, a storage area network (SAN), a telecommunications network, a local area network (LAN), a wide area network (WAN), such as the Internet, a wireless technology for exchanging data over short distances (using short-wavelength ultra-high frequency (UHF) radio waves in the industrial, scientific and medical (ISM) band from 2.4 to 2.485 GHz from fixed and mobile devices, and building personal area networks (PANs) or a combination of the three), and may include wired, wireless, or fiber optic connections. Network 130 may include one or more wired and/or wireless networks that may receive and transmit data, voice, and/or video signals, including multimedia signals that include voice, data, text and/or video data. In general, network 130 may be any combination of connections and protocols that will support communications between computing device 110 and server computer 120, and any other computing devices and/or storage devices (not shown in FIG. 1A) within distributed data processing environment 100.

In some embodiments of the present invention, computing device 110 may be, but is not limited to, a standalone device, a client, a server, a laptop computer, a tablet computer, a netbook computer, a personal computer (PC), a smart phone, a desktop computer, a smart television, a smart watch, a radio, a stereo system, a cloud based service (e.g., a cognitive cloud based service), AR glasses, a virtual reality headset, any HUD known in the art, and/or any programmable electronic computing device capable of communicating with various components and devices within distributed data processing environment 100, via network 130 or any combination therein. In general, computing device 110 may be representative of any programmable computing device or a combination of programmable computing devices capable of executing machine-readable program instructions and communicating with users of other computing devices via network 130 and/or capable of executing machine-readable program instructions and communicating with server computer 120. In some embodiments computing device 110 may represent a plurality of computing devices.

In some embodiments of the present invention, computing device 110 may represent any programmable electronic computing device or combination of programmable electronic computing devices capable of executing machine readable program instructions, manipulating executable machine-readable instructions, and communicating with server computer 120 and other computing devices (not shown) within distributed data processing environment 100 via a network, such as network 130. Computing device 110 may include an instance of user interface (interface) 106, and local storage 104. In various embodiments, not depicted in FIG. 1A, computing device 110 may have a plurality of interfaces 106. In other embodiments, not depicted in FIG. 1A, distributed data processing environment 100 may comprise a plurality of computing devices, plurality of server computers, and/or one a plurality of networks. Computing device 110 may include internal and external hardware components, as depicted, and described in further detail with respect to FIG. 5.

User interface (interface) 106 provides an interface to sustainable order fulfillment optimization component (component) 122. Computing device 110, via user interface 106, may enable a user and/or a client to interact with component 122 and/or server computer 120 in various ways, such as sending program instructions, receiving program instructions, sending and/or receiving messages, updating data, sending data, inputting data, editing data, collecting data, and/or receiving data. In one embodiment, interface 106 may be a graphical user interface (GUI) or a web user interface (WUI) and may display at least text, documents, web browser windows, user options, application interfaces, and instructions for operation. interface 106 may include data (such as graphic, text, and sound) presented to a user and control sequences the user employs to control operations. In another embodiment, interface 106 may be a mobile application software providing an interface between a user of computing device 110 and server computer 120. Mobile application software, or an “app,” may be designed to run on smart phones, tablet computers and other computing devices. In an embodiment, interface 106 may enable the user of computing device 110 to at least send data, input data, edit data (annotations), collect data and/or receive data.

Server computer 120 may be a standalone computing device, a management server, a web server, a mobile computing device, one or more client servers, or any other electronic device or computing system capable of receiving, sending, and processing data. In other embodiments, server computer 120 may represent a server computing system utilizing multiple computers such as, but not limited to, a server system, such as in a cloud computing environment. In another embodiment, server computer 120 may represent a computing system utilizing clustered computers and components (e.g., database server computers, application server computers, etc.) that act as a single pool of seamless resources when accessed within distributed data processing environment 100. Server computer 120 may include internal and external hardware components, as depicted, and described in further detail with respect to FIG. 5. In some embodiments server computer 120 may represent a plurality of server computers.

Each of shared storage 124 and local storage 104 may be a data/knowledge repository and/or a database that may be written and/or read by one or a combination of component 122, server computer 120 and computing device 110. In some embodiments, each of shared storage 124 and local storage 104 may be a data/knowledge repository, a knowledge base, a knowledge center, a knowledge corpus, and/or a database that may be written and/or read by one or a combination of component 122, server computer 120 and computing device 110. In the depicted embodiment, shared storage 124 resides on server computer 120 and local storage 104 resides on computing device 110. In another embodiment, shared storage 124 and/or local storage 104 may reside elsewhere within distributed data processing environment 100, provided that each may access and is accessible by computing device 110 and server computer 120. Shared storage 124 and/or local storage 104 may each be implemented with any type of storage device capable of storing data and configuration files that may be accessed and utilized by server computer 120, such as, but not limited to, a database server, a hard disk drive, or a flash memory. In various embodiments, not depicted in FIG. 1A, in addition to shared storage 124, server computer comprises a primary and a secondary database, described below in FIG. 5. The primary database, also referred to as primary storage device, may be one or more of any type of disk storage known in the art. The secondary database, also referred to as secondary storage device, may be one or more any type of tape storage known in the art.

In the depicted embodiment, component 122 is executed on server computer 120. In other embodiments, component 122 may be executed on computing device 110. In various embodiments of the present invention, not depicted in FIG. 1A, component 122 may execute on a plurality of server computers 120 and/or on a plurality of computing devices 110. In some embodiments, component 122 may be located and/or executed anywhere within distributed data processing environment 100 as long as component 122 is connected to and/or communicates with, computing device 110, and/or server computer 120, via network 130.

In various embodiments of the present invention, not depicted in FIG. 1A, order management system 126 may execute on a plurality of server computers 120 and/or on a plurality of computing devices 110. In some embodiments, order management system (OMS) 126 may be located and/or executed anywhere within distributed data processing environment 100 as long as order management system 126 are connected to and/or communicates with, computing device 110, component 122, and/or server computer 120, via network 130.

In various embodiments, component 122 receives and/or retrieves new order(s) from OMS 126, wherein the new order(s) comprise: the destination of the order, stock keeping unit (SKU) details, and promised/fulfillment data. Further, component 122 may receive and/or retrieve weightage data, freight-mode delivery (less than a truck load (LTL), full truck load (FTL)) data, and carrier transportation network information from a user, local storage 104, shared storage 124, or any combination thereof, and collectively referred to as order data. Component 122 may estimate emissions and economic costs of fulfilling this order from different a plurality of nodes based on the order data. In various embodiments, depending on the user preferences and/or order data, component 122 outputs, via interface 106, the optimal node, carrier, transport mode and vehicle to fulfil the order, collectively referred to as optimal order fulfillment. User preferences may be predetermined and/or customized/input by a user, via interface 106. In various embodiments, component 122 outputs one or more responsive prompts to a user that details the optimized order fulfillment and query’s the user to confirm or reject the optimized order fulfillment and/or customize the optimized order, via interface 106.

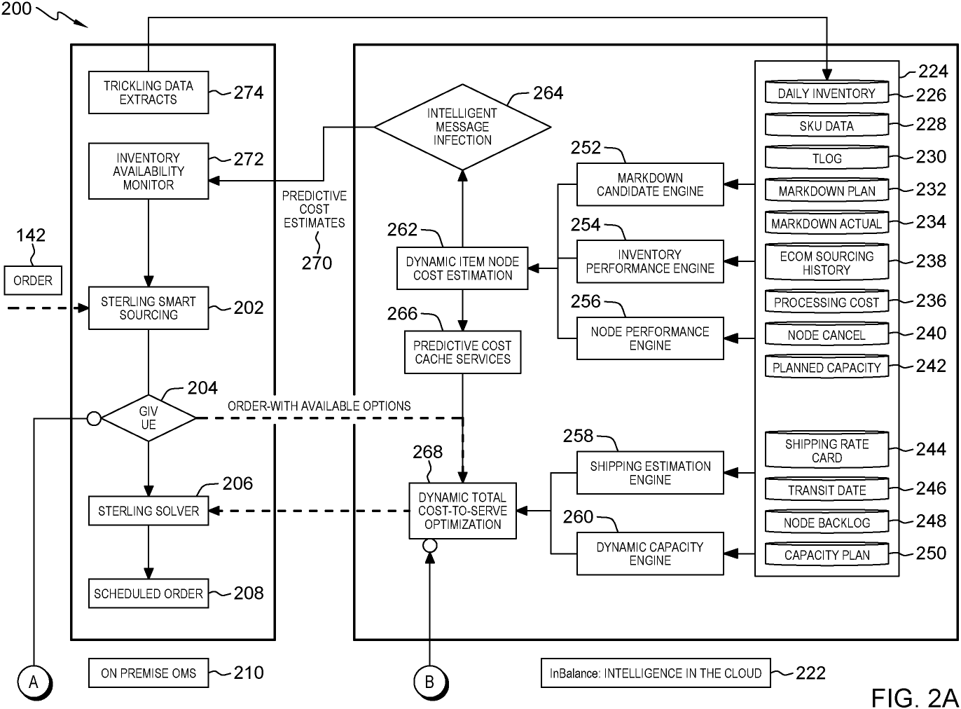

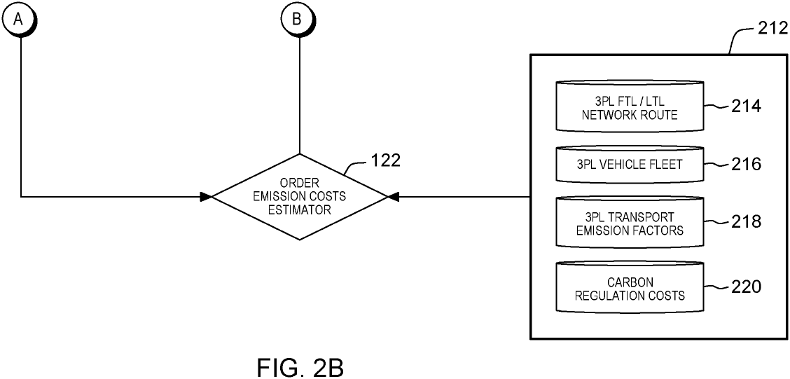

Component 122 may effectively interrogate the combined network of a company’s node structure (e.g., stores and distribution centers), the company’s customer endpoints, and the blackbox operations of third-party logistics (3PL) contractors, an example is illustrated in FIGS. 2A - 2B. By placing emphasis on optimizing the emissions associated with order-fulfillment, the opaque structure of 3PL route choice, the vehicle type and temporary package storage is resolved and can be manipulated to optimally lower emissions. Optimization focuses on which of the company nodes to ship from in order to reduce emissions while constraining the possible additional costs of shipping that may arise. Currently the cost associated with a reduction of emissions shadows in comparison to simply reducing shipping and inventory management costs. Fortunately, in the formulation of the optimization equation, weighting factors can be used to place emphasis on emissions. This embodiment functions as a “What-if” engine for a company who is planning operations in regions within unpredictable regulations. In various embodiments, component 122 improves the art and solves the problems stated above by executing computer analysis of electronic order management for product fulfillment. Component 122 may execute or facilitate a computer analysis of electronic order management for product fulfillment and output optimized fulfillment parameters based on the analysis, wherein the optimized fulfillment parameters comprise sustainable order fulfillment parameters. In various embodiments, fulfillment parameters and sustainable order fulfillment parameters are predetermined.

Component 122 may enable (i) systematic and detailed estimation of freight emissions, (ii) enable systematic estimation of dollar costs of emissions, and (iii) enable emission costs to be optimized along with other economic costs. In various embodiments, freight emissions due to order packages are typically delivered in two modes. The first is the full truck load mode (FTL), which represents the number of packages would ‘fill up a truck’ (>150 lbs.) and enables goods to be directly transported from origin to destination, typically by a single shipper. The second mode is the less than truck load mode (LTL), which is for small packages (<150 lbs.) and enables packages from different shippers to be consolidated into a single truck that makes various stops between origin and destination (origin-hub, destination-hub etc.), wherein, LTL contributes empty miles and idling time, wherein the empty miles, idling times, and pickup and delivery of a shipment need to be considered. In various embodiments, component 122 calculates and estimates an optimized sustainable order fulfillment based on freight emissions, wherein freight emissions comprise: transport mode, vehicle characteristics, and transport mode-switch.

A vehicle is any form of item transportation method (e.g., car, truck, train, boat, train, drone, and/or any other method used to transport, or delivery items known and understood in the art). The transport mode ranked in terms of emissions may be as follows: Water (Boat) < Rail (Train) < Road (Truck) < Air (Airplane). Further, component 122 factors in vehicle characteristics into the calculated and estimated optimized sustainable order fulfillment, wherein the vehicle characteristics comprise: vehicle engine, wear and tear, vehicle milage (e.g., miles per gallon (mpg)), load factor, weight, and volume. Component 122 may factor transport mode-switch in the calculated and estimated optimized sustainable order fulfillment, wherein the factor transport mode-switch is the emissions produced by the storing and transit of a package including the transferring between transport modes. Freight emissions are also affected by the distance used, therefore, component 122 calculates and estimates an optimized sustainable order fulfillment by computing an optimized fulfillment path (e.g., shortest feasible path used for road transport, ‘great circle distance’ used for air transport, most direct train route, and/or any other optimized fulfillment paths known and understood in the art). Component 122 may estimate the cost of freight-emissions based on, but not limited to, any prevailing carbon tax, cap-and-trade current price, carbon offset price, internal carbon price, social cost of carbon, and/or any other freight-emission cost elements known and understood in the art. In various embodiments, component 122 may balance the solution based on user-weightage to different economic and emission costs and yields optimal fulfillment node(s), carrier, transport mode and vehicle for a given order. In various embodiments, component 122 includes the estimated emission costs in the fulfillment optimization problem with the user-specified weightage either as an objective function or as a constraint with a known upper bound, with only the economic criteria as the objective function, see FIGS. 2A - 2B.

Component 122 may improve the art by improving an order management system to execute sustainable order fulfillment optimization. Component 122 may improve the art by (i) receiving an order from a user through the order management system for performing sustainable order fulfillment, (ii) estimating carbon emissions and economic costs of fulfilling the order from a plurality of nodes, (iii) outputting an optimal sustainable order fulfillment, wherein the optimal sustainable order fulfillment comprises an optimal: node, carrier, transport mode, and vehicle to fulfill the order based on consumer’s preference, (iv) outputting, by a user interface, one or more responsive prompts to a user that details the optimized order fulfillment and query’s the user to confirm or reject the optimized order fulfillment or customize the optimized order, (v) determining, by a performance engine, the demand and replenishment speed of an item in the order and outputting a replenishment schedule based on determined replenishments speed of the item, (vi) determining, by a node performance engine, an available node has an item of the order, available delivery options at a delivery node, and a capacity to fulfill the order at a desired time based on a backlog at the available node and outputting, by a user interface, a list of nodes that can execute the order successfully based on the determined availability of the order item, available delivery options at the delivery node, and the capacity to fulfill the order at the desired time, wherein the list of nodes is a ranked list that ranks nodes from most efficient and sustainable to least efficient and sustainable (vii) determining, by a node performance engine, information pertaining to a fulfillment node with a respective fulfillment cost, wherein an item node cost is cached at the node performance engine to be retrieved and used at later predetermined time to determine a total cost to serve and deliver the order, and (viii) placing the optimal sustainable order fulfillment for the received order, responsive to receiving confirmation to implement the output optimal sustainable order fulfillment.

FIGS. 1B and 1C are a functional block diagram illustrating a distributed data processing environment, generally designated 100, in accordance with one embodiment of the present invention. The term “distributed” as used in this specification describes a computer system that includes multiple, physically distinct devices that operate together as a single computer system. FIGS. 1B and 1C provides only an illustration of one implementation and does not imply any limitations with regard to the environments in which different embodiments may be implemented. Many modifications to the depicted environment may be made by those skilled in the art without departing from the scope of the invention as recited by the claims.

In the depicted embodiment, fulfillment order solution 140 comprises Nodes 142₁ -142₃ and illustrates the low shipping costs of order 146 from origin 144 from Node 142₁ to destination 149 through a third-party logistic ground transportation (transportation) 148, wherein Nodes 142₁ - 142₃ are each distribution centers. In the depicted embodiment, Node 142₁ receives order 146, wherein order 146 comprises SKU 01 and SKU 02 that each weigh one kilogram (1 kg). In fulfillment order solution 140 order 146 is transported fifty kilometers (km) to destination 149, via transportation 148 at a cost of $6.03 from a two-kilogram rate card and 20.4 gCO2 (2 kg, 50 km, 0.204 gCO₂/tonne-km) worth of carbon emissions. Thus, fulfillment order solution 140 comprises a lower shipping cost but higher carbon emission output. Conversely, in FIG. 1C, emission efficient fulfillment order solution 150 illustrates an emission efficient solution when compared to fulfillment order solution 140; however, emission efficient fulfillment order solution 150 comprises a higher shipping cost.

In the depicted embodiment, order 146 comprising SKU 01 and SKU 02 is divided into two separate shipments order 146₁ and order 146₂. In the depicted embodiment, order 146₁ comprises SKU 02 and is fulfilled by distribution center 143 in node 142₂, via transportation 148₁. Similarly, order 146₂ comprises SKU 01 and is fulfilled by distribution center 145 in node 142₃, via transportation 148₂. In the depicted embodiment, transportation 148₁ and transportation 148₂ each travel 10 km to destination 149 for a carbon emission cost of 2.04 gCO2 (1 kg, 10 km, 0.204 gCO₂/tonne-km) and shipping cost of $4.07 (based on a rate card from 1 kg rate card) for each shipment for order 146₁ and order 146₂, which brings the total carbon cost to 2.04 gCO2 and total shipping cost to $8.14. In the depicted embodiments, when comparing the examples in FIGS. 1B and 1C the lower shipping costs ($6.03 < $8.14) is due to of two-item package consolidation by the FO. However, the carbon emissions (20.4 gCO₂) can be reduced with an alternative shipping strategy. Fulfilling the order from two nearby DC’s / stores, the carbon emissions can be reduced to 16.32 gCO2 (< 20.4 gCO2), which leads to an increased shipping-cost of $8.14. Thus, FO consolidation decreases shipping costs but can also increase carbon emissions.

FIGS. 2A - 2B are a functional block diagram illustrating a distributed data processing environment, generally designated 200, in accordance with one embodiment of the present invention. The term “distributed” as used in this specification describes a computer system that includes multiple, physically distinct devices that operate together as a single computer system. FIGS. 2A - 2B provide only an illustration of one implementation and does not imply any limitations with regard to the environments in which different embodiments may be implemented. Many modifications to the depicted environment may be made by those skilled in the art without departing from the scope of the invention as recited by the claims. Distributed data processing environment 100 includes computing device 110, order 142, and server computer 120 interconnected over network 130.

In the depicted embodiment, on premise OMS (OMS) 210 comprising: trickling data extracts 274, inventory availability monitor 272, smart sourcing 202, GIV UE component 204, solver 206, and scheduled order 208. In the depicted embodiment, inbalance cloud intelligence 222 comprises: order shipping data 224, markdown candidate engine 252, inventory performance engine 254, node performance engine 256, shipping estimation engine 258, dynamic capacity engine 260, intelligent message injection 264, dynamic item node cost estimation 262, predictive cost cache services 266, and dynamic total cost-to-serve optimization 268. Further, in the depicted embodiment, order shipping data 224 comprises a plurality of nodes, wherein the plurality of nodes comprise: daily inventory 226, sku data 228, TLOG 230, markdown plan 232, markdown actual 234, ecom sourcing history 236, processing cost 238, node cancel 240, planned capacity 242, shipping rate card 244, transit date 246, node backlog 248, and capacity plan 250. Additionally, in the depicted embodiment, network logistics 212 comprises: third-party logistics (3PL) FTL/ LTL network route 214, 3PL vehicle fleet 216, 3PL transport emissions factors 218, and carbon regulation costs 220.

In the depicted embodiment order 142 is received by on premise OMS (OMS) 210, more specifically, smart sourcing 202 On OMS 210. Component 122 determines there is GIV UE submitted with order 142. GIV UE is a user defined flag that denotes whether emission cost will be computed as part of the objective function. In the depicted embodiment, if component 122 determines order 142 has available options, then component 122 sends order 142 to dynamic total cost-to-serve optimization 268, wherein dynamic total cost-to-serve optimization 268 calculates an optimized cost-to-serve total for order 142 based on the identified available order options based on configurable carbon-emissions constraints and thresholds. In the depicted embodiment, component 122 instructs dynamic total cost-to-serve optimization 208 to send the optimized cost-to-serve total to solver 206 on OMS 210, wherein scheduled order 208 is an optimized sustainable fulfillment placed for order 142. solver 206 may receive and/or retrieve optimized cost-to-serve total from dynamic total cost-to-serve optimization 268.

In the depicted embodiment, order shipping data 224 receives trickling data extracts 274 from OMS 210, wherein the received trickling data extracts 274 are parsed and stored in one or more of the plurality of nodes on order shipping data 224. In the depicted embodiment, markdown candidate engine 252, inventory performance engine 254, and node performance engine 256 each receive and/or retrieve order data from one or more of the nodes on order shipping data 224. Markdown candidate engine 252 may determine if an item from a given node has probable price reduction. It is possible for an item to have a markdown at one order fulfillment center and not in another. Component 122 may receive data from the markdown plan 232 and markdown actual collection 234. Markdown plan 232 outputs the markdown cost for every ranked node, wherein ranked nodes represent discrete variables whose states are expressed on an ordinal scale that can be mapped onto a bounded numerical scale that is continuous and monotonically ordered. The inventory performance engine 254 determines the supply and demand of all SKUs. Performance engine 254 determines how the items in an order are being demanded and how fast the items are being replenished at each node. Performance engine 254 may receive input from emission control (ecom) sourcing history 236 and outputs a replenishment schedule based on the item’s demand (i.e., demand for order 142). Node performance engine 256 determines if the available nodes have the order item, the available delivery options at the said delivery node as well as the capacity to fulfill the said order at the appropriate time based on the backlog at the node. Node performance engine 256 receives input from node cancel 240 and planned capacity 242, wherein node performance engine 256 may output the top nodes that can execute the order successfully.

Similarly, shipping estimation engine 258, and dynamic capacity engine 260 each receive and/or retrieve shipping data from one or more nodes on order shipping data 224. The shipping estimation engine 258 determine the shipping cost of fulfilling the order based on the delivery zone. The information is retrieved from the shipping rate card 244 which contains the pricing matrix from every fulfillment node to a destination zone. Most of the destination zones are determined by the destination zip code. Shipping estimation engine 258 may output the shipping cost from all ranked nodes, wherein dynamic capacity engine 260 determines whether the nodes can fulfill the order based on the backlog at the available node as well as the capacity of the available carriers. This will determine the delivery date of a given item. Shipping estimation engine 258 may receive input from node backlog 248, transit date 246 and capacity plan 250. It provides the possible delivery date based on the backlog and carriers’ capacity at the nodes. In the depicted embodiment, dynamic item node cost estimation 262 receives input data from markdown candidate engine 252, inventory performance engine 254, and/or node performance engine 256, wherein dynamic item node cost estimation 262 outputs data to intelligent message injection 264 and predictive cost cache services 266. In the depicted embodiment, intelligent message injection outputs the predictive cost estimates to inventory availability monitor 272 to be accounted in the generated optimized sustainable fulfillment of order 142.

In the depicted embodiment, dynamic total cost-to-serve optimization 268 receives input data from predictive cost cache services 266, component 122, estimation engine 258, and dynamic capacity engine 260, wherein dynamic total cost-to-serve optimization 268 outputs order optimization data to solver 206 to be accounted in the generated optimized sustainable fulfillment of order 142. Further, in the depicted embodiment, component 122 receives and/or retrieves data input from GIV UE component 204 and network logistics 212, wherein component 122 outputs data to dynamic total cost-to-serve optimization 268. In the depicted embodiment, once solver 206 receives the input data from dynamic total cost-to-serve optimization 268 component 122 instructs solver 206 to generate an optimized sustainable fulfillment order for order 142 and schedule order 142, via scheduled order 208.

For example, in the depicted embodiment, when order 142 arrives at smart sourcing component (smart sourcing) 202, data pertaining to order 142 (i.e., order shipping data 224) are retrieved by different components to determine the item, its availability and the available supply and demand. Such data comprises daily inventory 226, SKU data 228, processing cost 238 per node, capacity 242 and other markdown cost. From then, component 122 determines dynamic item node cost estimation 262 for fulfilling order 142. Since it is an omnichannel environment with multiple fulfillment nodes and multiple delivery carriers, it is important to determine the cost of fulfillment that minimizes overall cost. Thereby the markdown cost is determined by the markdown candidate engine 252, the inventory related information that seeks to determine the demand and availability of the items in the order are determined by the inventory performance engine 254, and lastly, information pertaining to the fulfillment nodes with a respective fulfillment cost is determined by node performance engine 256. The item node cost is cached at node performance engine 256 to be used by later to determine the total cost to serve. The meta data of the dynamic node cost estimation that contains SKU and inventory data is sent to inventory monitor 272 through intelligent message injection 264.

At this point, smart sourcing 202 will have all the available information pertaining the said order. It sends the information to GIV UE component 204, that will identify various fulfillment options that may have been dictated by the end user. These options are sent to the dynamic total cost-to-serve optimizer 268 to help eliminate the candidates no longer required based on the criteria set by GIV UE. Dynamic total cost-to-serve optimizer 268 may receive all the information pertaining to the shipping cost from component 258 based on the shipping rate card information in the database. The dynamic capacity engine 260 will determine delivery information based on the available capacity. It would determine the most appropriate date for delivery for every ground or air-based carrier. That information changes constantly due to the priority nature of orders and thus why it is dynamic in nature. At this point, the optimizer contains the item-node cost for all nodes that can fulfill the order as well as the shipping cost from all the said nodes and the available carriers and possible delivery date. At this moment, component 122 then add the emission cost for the said delivery options.

Component 122 determines the emission or carbon cost for delivering the order. The emission cost is determined by the delivery distance, the weight of the order as well as the emission factors. To determine the emission factor, component 122 determine the network route provided by component 214, the 3PL vehicle fleet determined by component 216 as well as the 3PL transport emission factors 218 based on whether the item will be transported by ground transport or air transport. Other cost including regulatory cost are determined by carbon regulation costs 220. The emission cost is sent to the dynamic total cost-to-serve optimization 258 which creates an objective function and the related constrains as it seeks to minimize the overall cost to serve. Solver 206 solves the objective function that seeks to minimize the shipping cost, the item node cost and the emission cost. This determines the most appropriate node to fulfill the order, as well as the most appropriate carrier based on the delivery date and emission cost. The data in now used to schedule the order through dynamic total cost-to-serve optimization 268.

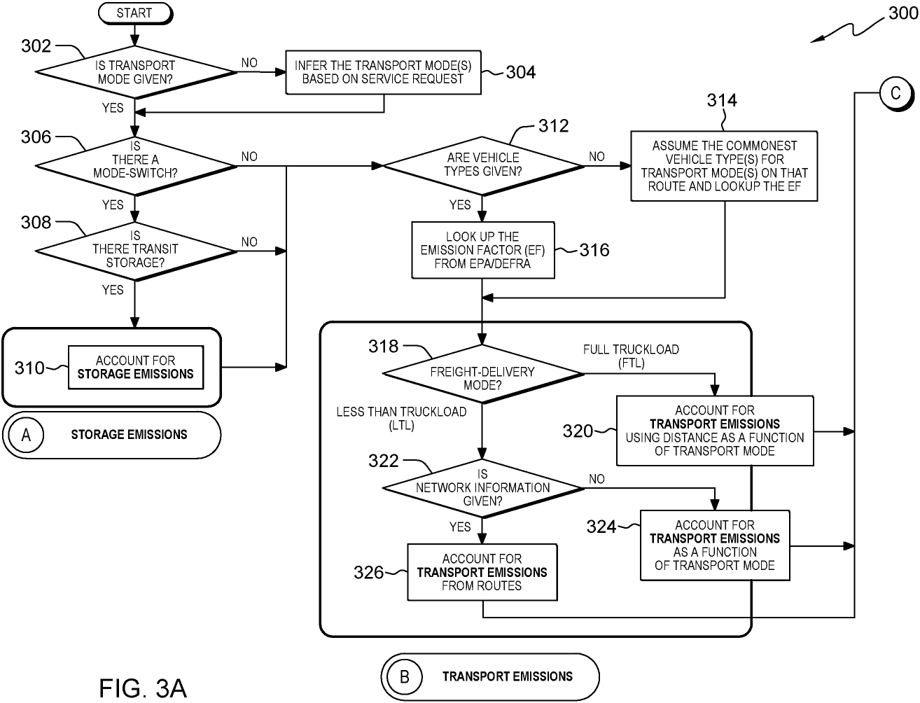

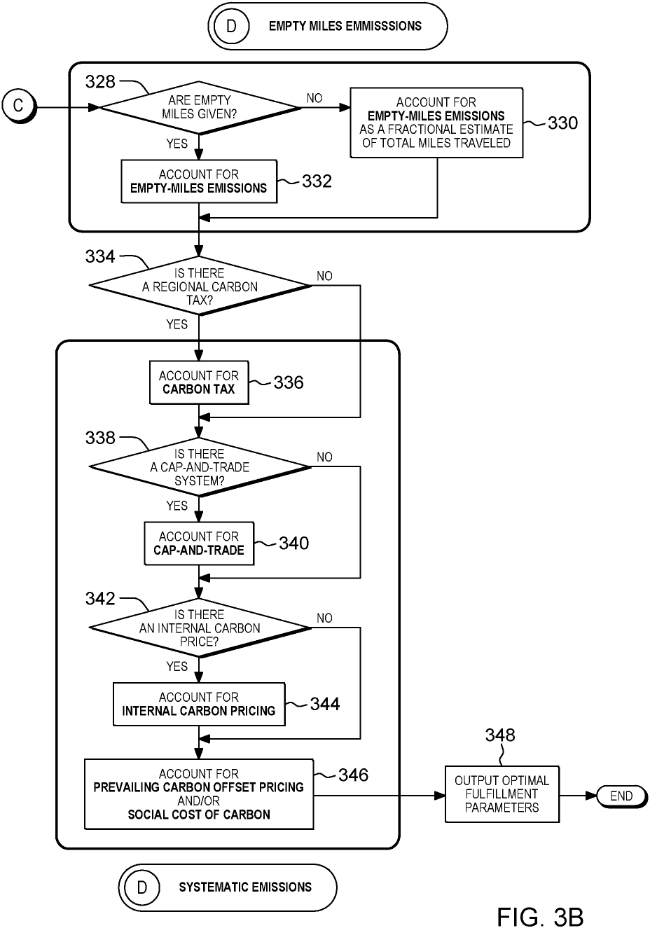

FIGS. 3A - 3B illustrate operational steps of component 122, generally designated 300, in communication with server computer 120, within distributed data processing environment 100 of FIG. 1A, for sustainable order fulfillment optimization on an order management system, in accordance with an embodiment of the present invention. FIGS. 3A -3B provide an illustration of one implementation and does not imply any limitations with regard to the environments in which different embodiments may be implemented. Many modifications to the depicted environment may be made by those skilled in the art without departing from the scope of the invention as recited by the claims.

In step 302, component 122 determines if a transport mode is given. In various embodiments, component 122 determines if the transport mode for an order has been input by a user or is part of an order detail received by component 122. For example, given a set of fulfillment nodes, component 122 receives a new order comes comprising a SKU, destination and service-name information (e.g., fulfilled by shipment(s) from origin(s) / fulfillment node(s)). In the depicted embodiments, if the transport mode is given, (Yes step), then component 122 advances to step 306; however, if the transport mode is not given, (No step), then component 122 advances to step 304.

In step 304, component 122 infers the transport mode. In various embodiments, component 122 infers the transport mode of an order based on one or more service requests. In some embodiments, the service request data may comprise transport mode preferences. In other embodiments, component 122 may retrieve historic service request data, and user preference data from previous orders from local storage 104 and/or shared storage 124 with similar order features as the present feature. For example, comparing previously submitted orders (historical orders) comprising the same origin and destination locations, the same company name or username, user or company shipping preferences, type product being shipped, amount of product being shipped, previously used shipping methods, cost of shipping, and/or any other shipping order information known and understood in the art.

In step 306, component 122 determines if there is a mode-switch. In various embodiments, component 122 determines if there is a transport mode-switch submitted in the received new order (i.e., received order). In the depicted embodiment, if component 122 determines there is a mode-switch in the received new order, (Yes step), then component 122 advances to step 308; however, if component 122 determines there is no mode-switch in the received new order, (No step), then component 122 advances to step 312.

In step 308, component 122 determines if there is transit storage. In various embodiments component 122 determines if the received new order comprises transit storage based on the order details and/or order data input by the user. In the depicted embodiment, if component 122 determines there is a transit storage in the received new order, (Yes step), then component 122 advances to step 310; however, if component 122 determines there is no transit storage in the received new order, (No step), then component 122 advances to step 312.

In step 310, component 122 accounts for storage emissions. In various embodiments, component 122 accounts for the storage emissions of the received new order’s transit storage.

In step 312, component 122 determines if a vehicle type is given. In various embodiments, component 122 determines if one or more vehicle types have been given in the received order based on the order details and/or user preferences. In the depicted embodiment, if component 122 determines there is a vehicle type entered in the received new order, (Yes step), then component 122 advances to step 316; however, if component 122 determines there is no vehicle type listed in the received new order, (No step), then component 122 advances to step 314.

In step 314, component 122 assumes a vehicle type for the received order. In various embodiments, component 122 assumes the vehicle type for the received order based on common vehicles used for the transport mode(s) used for route of the received order and by identified and/or retrieved emissions factor (EF) from a user, local storage 104, and/or shared storage 124. If no, infer the transport mode based on service requested, and assume commonest vehicle type for that mode on that route e.g. NXTDAY service and >200 mi, then mode = ‘AIR’ etc.

In step 316, component 122 retrieves emissions factor (EF) from the Environmental Protection Agency (EPA) and the Department for Environment, Food and Rural Affairs (DEFRA). In various embodiments, component 122 retrieves the EF of the determined/identified vehicle type(s) from the EPA and/or DEFRA. The EF may be retrieved from an API service that computes the emission factors given certain parameters such as the transport mode, the carrier vehicle, the country of delivery, and/or any other parameters pertaining to the order and/or shipping details. Since the emission factor changes dynamically over time due to changing environmental variables, the emission factors will be retrieved periodically and cached into the local database for fast retrieval. A look-up audit service will periodically determine if there has been a change in the emission factors provided by the EPA and reconcile the local database with the latest emission factors figure in case of such change.

In step 318, component 122, determines the freight-delivery mode. In various embodiments, component 122 determines the freight-delivery mode based on the identified vehicle type, transport mode, transit storage, and/or any identified mode-switch of the received order. In the depicted embodiment, if component 122 determines the freight-delivery mode is a full truckload (FTL), (FTL step), then component 122 advances to step 320; however, if component 122 determines the freight-delivery mode is less than a truckload (LTL), (LTL step), then component 122 advances to step 322. If yes, use it to determine routes (including pickup and delivery). If no, compute distance as function of transport mode are empty miles / idling time given? If yes, account for those. If not, estimate them as fraction of total miles traveled.

In step 320, component 122 accounts for the transport emissions of the received order. In various embodiments, component 122 accounts for the transportation emission of the received order by using distance as a function of transport mode when the freight-delivery mode is an FTL.

In step 322, component 122 determines if the network information is given. In various embodiments, component 122 determines if the network information for the received order is present in the order information and/or submitted by the user. Network information refers to the transport mode routing information such as the path selected from the fulfillment center to the delivery zone. Network information accounts for traffic information for ground transport and layover information for air transport. Information such as traffic may have additional contribution to emissions and thus would add onto the emissions per order component if the said network information is provided. In the depicted embodiment, if component 122 determines there is network information given in the received new order, (Yes step), then component 122 advances to step 326; however, if component 122 determines there is no network information in the received new order, (No step), then component 122 advances to step 324.

In step 324, component 122 accounts for transport emissions. In various embodiments, component 122 accounts for transport emissions as a function of transport mode.

In step 326, component 122 accounts for the transport emissions based on the received orders routes. In various embodiments, component 122 accounts for the transports emissions based on the received order’s route(s) through the network information, wherein component 122 calculates the transport emissions based on the global positioning system (GPS) route of the received order.

In step 328, component 122 determines if empty miles are given. In various embodiments, component 122 determines if empty miles are given in the received order. Empty miles refer to the millage when a truck is not earning any revenue when on the road. Empty miles mainly occur when empty trucks return to fulfillment centers after delivery. Another example is when trucks travel to a fulfillment location to collect orders. In this case, the trucks are still emitting emissions. In the depicted embodiment, if component 122 determines empty miles given in the received new order, (Yes step), then component 122 advances to step 332; however, if component 122 determines no empty miles in the received new order, (No step), then component 122 advances to step 330.

In step 330, component 122 accounts for empty-miles emissions as a fractional estimate of total miles traveled. In various embodiments, responsive to determining no empty miles were given in the received order, component 122 accounts for empty-miles emissions as a fractional estimate of total miles traveled.

In step 332, component 122 accounts for empty-miles emissions based on the transport emissions from the route of the received. In various embodiments, component 122 accounts for empty-miles based on the transportation emissions. In various embodiments, if empty miles are provided in the order information, then the emissions derived from the empty miles are added onto the already computed emission figure for order delivery. In this case, the total emission for an order will be the sum emissions for order delivery from origin to destination and the empty miles emissions per order.

In step 334, component 122 determines if there is a regional carbon tax. In the depicted embodiment, component 122 determines if there is a regional carbon tax based on the received order’s travel route and local/regional tax laws. In the depicted embodiment, if component 122 determines there is a regional carbon tax on the received new order’s route/estimated route, (Yes step), then component 122 advances to step 336; however, if component 122 determines there is no regional carbon tax on the received new order’s route/estimated route, (No step), then component 122 advances to step 338.

In step 336, component 122 accounts for the carbon tax. In various embodiments, component 122 accounts for the determined/identified regional carbon tax on the received order’s route.

In step 338, component 122 determines if there is a cap-and-trade system. In various embodiments, component 122 determines if there is a cap-and-trade system on the received order. Cap-and-trade system is the government set emissions cap and issue of a quantity emission allowances consistent with that cap. Emitters must hold allowances for every ton of greenhouse gas they emit. Companies may buy and sell allowances, and this market establishes an emissions price. In the depicted embodiment, if component 122 determines there is a cap-and-trade system on the received new order, (Yes step), then component 122 advances to step 340; however, if component 122 determines there is no cap-and-trade system on the received order, (No step), then component 122 advances to step 342.

In step 340, component accounts for the cap-and-trade system. In various embodiments, component 122 accounts for the cap-and-trade system in the calculated optimal fulfillment parameters.

In step 342, component 122 determines if there is an internal carbon price. In various embodiments, component 122 determines if there is one or more internal carbon prices for the received order. In the depicted embodiment, if component 122 determines there is one or more internal carbon prices for the received order, (Yes step), then component 122 advances to step 344; however, if component 122 determines there is no internal carbon prices for the received order, (No step), then component 122 advances to step 346.

In step 344, component 122 accounts for internal carbon pricing. In various embodiments, component 122 accounts for internal carbon pricing as a factor in the optimal fulfillment parameters.

In step 346, component 122 accounts for prevailing carbon offset pricing. In various embodiments component 122 accounts for prevailing carbon offset pricing and/or social cost of carbon as a factor in the optimal fulfillment parameters.

In step 348, component 122 outputs optimal fulfillment parameters for the received order. In various embodiments, component 122, via interface 106, outputs one or more optimal fulfillment parameters to a user. In various embodiments, the output optimal fulfillment parameters are used to generate a delivery schedule for the order. The parameters are used by the solver 206 to determine the optimal fulfillment node (origin) and the most ideal carrier based on the transport mode and the delivery date. This information finally determines the scheduled order 208.

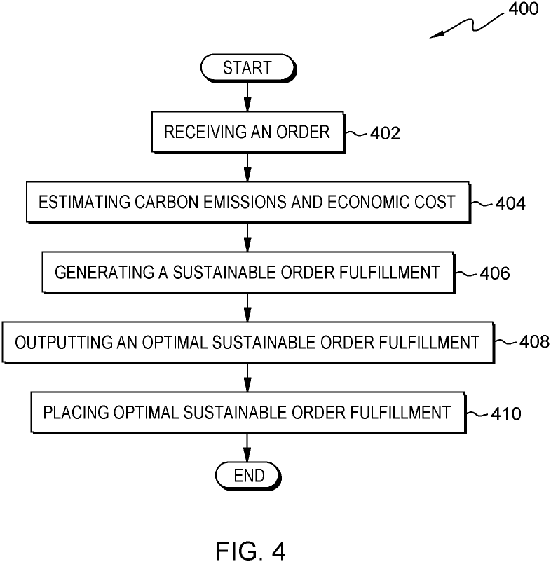

FIG. 4 illustrates operational steps of component 122, generally designated 400, in communication with server computer 120, within distributed data processing environment 100 of FIG. 1A, for sustainable order fulfillment optimization on an order management system, in accordance with an embodiment of the present invention. FIG. 4 provides an illustration of one implementation and does not imply any limitations with regard to the environments in which different embodiments may be implemented. Many modifications to the depicted environment may be made by those skilled in the art without departing from the scope of the invention as recited by the claims.

In step 402, component 122 receives an order. In various embodiments, component 122 receives and/or retrieves one or more orders from a user or from order management system 126.

In step 404, component 122 estimates carbon emission and economic costs for the received order. In various embodiments, component 122 estimates carbon emission and economic costs for the one or more received and/or retrieved orders.

In step 406, component 122 generates a sustainable order fulfillment for the received order. In various embodiments, component 122 generates one or more sustainable order fulfillments for the one or more received and/or retrieved orders based on the estimated carbon emission and economic costs. Component 122 may generate an optimal sustainable order fulfillment for the one or more received and/or retrieved orders based on the estimated carbon emission and economic costs.

In step 408, component 122 outputs an optimal sustainable order fulfillment to user. In various embodiments, component 122 outputs one or more optimal sustainable order fulfillments to a user, distribution center, transportation company, and/or 3PL.

In step 410, places the optimal sustainable order fulfillments for the received order. In various embodiments, component 122 places the optimal sustainable order fulfillments for the one or more received and/or retrieved orders. In some embodiments, responsive to receiving confirmation to use the output optimal sustainable order fulfillment, places the optimal sustainable order fulfillments for the received order.

FIG. 5 depicts a block diagram of components of server computer 120 within distributed data processing environment 100 of FIG. 1A, in accordance with an embodiment of the present invention. It should be appreciated that FIG. 5 provides only an illustration of one implementation and does not imply any limitations with regard to the environments in which different embodiments may be implemented. Many modifications to the depicted environment may be made.

FIG. 5 depicts computer system 500, where server computing 120 represents an example of computer system 500 that includes component 122. The computer system includes processors 501, cache 503, memory 502, persistent storage 505, communications unit 507, input/output (I/O) interface(s) 506, display 509, external device(s) 508 and communications fabric 504. Communications fabric 504 provides communications between cache 503, memory 502, persistent storage 505, communications unit 507, and input/output (I/O) interface(s) 506. Communications fabric 504 may be implemented with any architecture designed for passing data and/or control information between processors (such as microprocessors, communications, and network processors, etc.), system memory, peripheral devices, and any other hardware components within a system. For example, communications fabric 504 may be implemented with one or more buses or a crossbar switch.

Memory 502 and persistent storage 505 are computer readable storage media. In this embodiment, memory 502 includes random access memory (RAM). In general, memory 502 may include any suitable volatile or non-volatile computer readable storage media. Cache 503 is a fast memory that enhances the performance of processors 501 by holding recently accessed data, and data near recently accessed data, from memory 502.

Program instructions and data used to practice embodiments of the present invention may be stored in persistent storage 505 and in memory 502 for execution by one or more of the respective processors 501 via cache 503. In an embodiment, persistent storage 505 includes a magnetic hard disk drive. Alternatively, or in addition to a magnetic hard disk drive, persistent storage 505 may include a solid-state hard drive, a semiconductor storage device, read-only memory (ROM), erasable programmable read-only memory (EPROM), flash memory, or any other computer readable storage media that is capable of storing program instructions or digital information.

The media used by persistent storage 505 may also be removable. For example, a removable hard drive may be used for persistent storage 505. Other examples include optical and magnetic disks, thumb drives, and smart cards that are inserted into a drive for transfer onto another computer readable storage medium that is also part of persistent storage 505.

Communications unit 507, in these examples, provides for communications with other data processing systems or devices. In these examples, communications unit 507 includes one or more network interface cards. Communications unit 507 may provide communications through the use of either or both physical and wireless communications links. Program instructions and data used to practice embodiments of the present invention may be downloaded to persistent storage 505 through communications unit 507.

I/O interface(s) 506 enables for input and output of data with other devices that may be connected to each computer system. For example, I/O interface 506 may provide a connection to external devices 508 such as a keyboard, keypad, a touch screen, and/or some other suitable input device. External devices 508 may also include portable computer readable storage media such as, for example, thumb drives, portable optical or magnetic disks, and memory cards. Software and data used to practice embodiments of the present invention may be stored on such portable computer readable storage media and may be loaded onto persistent storage 505 via I/O interface(s) 506. I/O interface(s) 506 also connect to display 509.

Display 509 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium may be any tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures (i.e., FIG.) illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for improving order management by performing sustainable order fulfillment optimization through computer analysis, the computer-implemented method comprising:
receiving an order from a user through the order management system for performing sustainable order fulfillment;
estimating carbon emissions and economic costs of fulfilling the order from a plurality of nodes;
outputting an optimal sustainable order fulfillment, wherein the optimal sustainable order fulfillment comprises an optimal: node, carrier, transport mode, and vehicle to fulfill the order based on consumer’s preference; and
responsive to receiving confirmation to implement the output optimal sustainable order fulfillment, placing the optimal sustainable order fulfillment for the received order.

2. The computer-implemented method of claim 1, further comprising:
outputting, by a user interface, one or more responsive prompts to a user that details the optimized order fulfillment and query’s the user to confirm or reject the optimized order fulfillment or customize the optimized order.

3. The computer-implemented method of claim 1, further comprising:
determining, by a performance engine, the demand and replenishment speed of an item in the order; and
outputting a replenishment schedule based on determined replenishments speed of the item.

4. The computer-implemented method of claim 1, further comprising:
determining, by a node performance engine, an available node has an item of the order, available delivery options at a delivery node, and a capacity to fulfill the order at a desired time based on a backlog at the available node.

5. The computer-implemented method of claim 4, further comprising:
outputting, by a user interface, a list of nodes that can execute the order successfully based on the determined availability of the order item, available delivery options at the delivery node, and the capacity to fulfill the order at the desired time.

6. The computer-implemented method of claim 5, wherein the list of nodes is a ranked list that ranks nodes from most efficient and sustainable to least efficient and sustainable.

7. The computer-implemented method of claim 1, further comprising:
determining, by a node performance engine, information pertaining to a fulfillment node with a respective fulfillment cost, wherein an item node cost is cached at the node performance engine to be retrieved and used at later predetermined time to determine a total cost to serve and deliver the order.

8. A computer system for improving order management by performing sustainable order fulfillment optimization through computer analysis, the computer system comprising:
one or more computer processors;
one or more computer readable storage devices;
program instructions stored on the one or more computer readable storage devices for execution by at least one of the one or more computer processors, the stored program instructions comprising:
program instructions to receive an order from a user through the order management system for performing sustainable order fulfillment;
program instructions to estimate carbon emissions and economic costs of fulfilling the order from a plurality of nodes;
program instructions to output an optimal sustainable order fulfillment, wherein the optimal sustainable order fulfillment comprises an optimal: node, carrier, transport mode, and vehicle to fulfill the order based on consumer’s preference; and
responsive to receiving confirmation to implement the output optimal sustainable order fulfillment, program instructions to place the optimal sustainable order fulfillment for the received order.

9. The computer system of claim 8, further comprising:
program instructions to output, by a user interface, one or more responsive prompts to a user that details the optimized order fulfillment and query’s the user to confirm or reject the optimized order fulfillment or customize the optimized order.

10. The computer system of claim 8, further comprising:
program instructions to determine, by a performance engine, the demand and replenishment speed of an item in the order; and
program instructions to output a replenishment schedule based on determined replenishments speed of the item.

11. The computer system of claim 8, further comprising:
program instructions to determine, by a node performance engine, an available node has an item of the order, available delivery options at a delivery node, and a capacity to fulfill the order at a desired time based on a backlog at the available node.

12. The computer-implemented method of claim 11, further comprising:
program instructions to output, by a user interface, a list of nodes that can execute the order successfully based on the determined availability of the order item, available delivery options at the delivery node, and the capacity to fulfill the order at the desired time.

13. The computer-implemented method of claim 12, wherein the list of nodes is a ranked list that ranks nodes from most efficient and sustainable to least efficient and sustainable.

14. The computer system of claim 8, further comprising:
program instructions to determine, by a node performance engine, information pertaining to a fulfillment node with a respective fulfillment cost, wherein an item node cost is cached at the node performance engine to be retrieved and used at later predetermined time to determine a total cost to serve and deliver the order.

15. A computer program product for improving order management by performing sustainable order fulfillment optimization through computer analysis, the computer program product comprising:
one or more computer readable storage devices and program instructions stored on the one or more computer readable storage devices, the stored program instructions comprising:
program instructions to receive an order from a user through the order management system for performing sustainable order fulfillment;
program instructions to estimate carbon emissions and economic costs of fulfilling the order from a plurality of nodes;
program instructions to output an optimal sustainable order fulfillment, wherein the optimal sustainable order fulfillment comprises an optimal: node, carrier, transport mode, and vehicle to fulfill the order based on consumer’s preference; and
responsive to receiving confirmation to implement the output optimal sustainable order fulfillment, program instructions to place the optimal sustainable order fulfillment for the received order.

16. The computer program product of claim 15, further comprising:
program instructions to output, by a user interface, one or more responsive prompts to a user that details the optimized order fulfillment and query’s the user to confirm or reject the optimized order fulfillment or customize the optimized order.

17. The computer program product of claim 15, further comprising:
program instructions to determine, by a performance engine, the demand and replenishment speed of an item in the order; and
program instructions to output a replenishment schedule based on determined replenishments speed of the item.

18. The computer program product of claim 15, further comprising:
program instructions to determine, by a node performance engine, an available node has an item of the order, available delivery options at a delivery node, and a capacity to fulfill the order at a desired time based on a backlog at the available node.

19. The computer-implemented method of claim 15, further comprising:
program instructions to output, by a user interface, a list of nodes that can execute the order successfully based on the determined availability of the order item, available delivery options at the delivery node, and the capacity to fulfill the order at the desired time, wherein the list of nodes is a ranked list that ranks nodes from most efficient and sustainable to least efficient and sustainable.

20. The computer program product of claim 15, further comprising:
program instructions to determine, by a node performance engine, information pertaining to a fulfillment node with a respective fulfillment cost, wherein an item node cost is cached at the node performance engine to be retrieved and used at later predetermined time to determine a total cost to serve and deliver the order.
